(19) United States
(12) Patent Application Publication
(10) Pub. No.: US 2006/0239674 A1
(43) Pub. Date: Oct. 26, 2006

(54) System and method for analyzing a digital image

(76) Inventors: Susan E. Manson, Fort Collins, CO (US); Murray Dean Craig, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/412,155

(22) Filed: Apr. 26, 2006

Related U.S. Application Data
(63) Continuation-in-part of application No. 11/054,291, filed on Feb. 8, 2005.
Application No. 11/054,291 is a continuation-in-part of application No. 10/461,600, filed on Jun. 12, 2003.

(51) Int. Cl. G03B 17/18

(52) U.S. Cl. 396/281

(57) ABSTRACT

Methods of improving an image captured by a digital camera are disclosed herein. One embodiment of the method comprises providing information regarding changing at least one camera setting if the following conditions are met: the image is out of focus; the image was captured using an ISO above a preselected value; the camera was able to obtain a focus lock during image capture; the camera was below a predetermined handheld limit during image capture; the light intensity at the time of image capture was below a predetermined value; and a strobe associated with the digital camera was not activated during image capture.

This application is a continuation in part of Ser. No. 11/054,291, filed on Feb. 8, 2005, which is a continuation in part of Ser. No. 10/461,600, filed Jun. 12, 2003, for SYSTEM AND METHOD FOR ANALYZING A DIGITAL IMAGE, which are hereby incorporated by reference for all that is disclosed therein

### BACKGROUND

With the proliferation of low cost microprocessors, memory, and image capture electronics, digital cameras are gaining popularity and are becoming more and more widely available to a larger number of consumers. One of the advantages of a digital camera over a conventional film camera is that when a digital camera captures an image, the image is stored electronically in a memory element associated with the camera and is available for immediate viewing. For example, it is common to capture an image using a digital camera and then immediately display the captured image on a display screen associated with the digital camera. This ability to immediately view the image is commonly referred to as “instant review.” The ability to immediately review the recaptured image allows the user to immediately decide whether the image is satisfactory and worth keeping. The image may then be printed at a later time.

Many characteristics for determining whether the image is satisfactory may not be readily visually noticeable on the small display associated with many digital cameras. The displays used on the cameras typically are not able to display an image with the clarity of a printed image. Therefore, the user may not be able to determine whether image quality was optimized simply by viewing the image displayed on the display. For example, while the image may appear to be in focus and exposed properly when viewed on the camera display, the image may appear out of focus and improperly exposed when it is printed. Unfortunately, printing the image is a time consuming and costly way to determine whether an image is satisfactory.

### BRIEF DESCRIPTION OF THE DRAWINGS

FIG. 1 is a block diagram illustrating an embodiment of a digital camera.

FIG. 2 is a graphical illustration of an embodiment of an image file.

FIG. 3 is a flow chart describing the operation of an embodiment of the image analysis and improvement logic of FIG. 1.

FIG. 4 is a flowchart describing an embodiment for detecting focus errors and suggesting corrections thereto.

FIG. 5 is a flowchart describing other embodiments for detecting focus errors and suggesting corrections thereto.

FIG. 6 is a flowchart describing an embodiment of detecting exposure problems and suggestions thereto.

### DETAILED DESCRIPTION

Devices and methods for analyzing images are described herein. The devices and methods described herein analyze image data that is representative of images. The devices and methods for analyzing images may be implemented in hardware, software, firmware, or a combination thereof. In one embodiment, the system and method for analyzing images are implemented using a combination of hardware, software or firmware that is stored in a memory and that is executable by a suitable instruction execution system. In the embodiments described herein, the device is a digital camera wherein software stored on hardware in the camera analyzes image data or otherwise instructs the digital camera to analyze image data.

The hardware portion of the system and method for analyzing a captured image can be implemented with any or a combination of the following technologies, which are all well known in the art: a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc. The software portion of the system and method for analyzing a captured image can be stored in one or more memory elements and executed by a suitable general purpose or application specific processor.

The software for analyzing images, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means, which contain, store, communicate, propagate, or transport the program for use by or in connection with the instruction execution system, apparatus, or device.

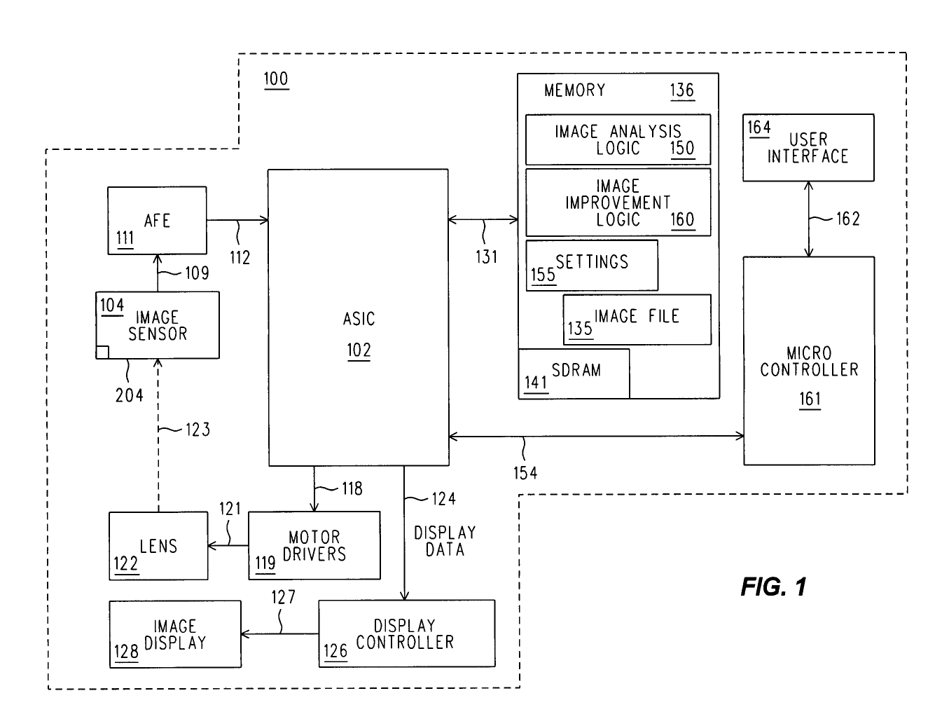

FIG. 1 is a block diagram illustrating an embodiment of a digital camera 100, which is sometimes referred to herein simply as a camera 100. In the implementation to be described below, the digital camera 100 includes an application specific integrated circuit (ASIC) 102 that executes the image analysis logic 150 described herein. As will be described below, the image analysis logic 150 can be software that is stored in memory and executed by the ASIC 102. In an alternative embodiment, the image analysis logic 150 maybe be implemented in firmware, which can be stored and executed in the ASIC 102. Further, while illustrated using a single ASIC 102, the digital camera 100 may include additional processors, digital signal processors (DSPs) and ASICs. It should be noted that the ASIC 102 may include other elements, which have been omitted. As described in greater detail below, the ASIC 102 controls many functions of the digital camera 100.

The camera 100 includes an image sensor 104. The image sensor 104 may comprise a charge coupled device (CCD) or an array of complementary metal oxide semiconductors (CMOS), which are both arrays of light sensors. Both the CCD and the CMOS sensor includes a two-dimensional array of photosensors, which are sometimes referred to as pixels. The pixels convert specific wavelengths or colors of light intensities to voltages that are representative of the light intensities. In one embodiment, higher pixel values or voltages are representative of higher intensities of light and lower pixel values are representative of lower intensities of light.

In one embodiment of the camera 100, the image sensor 104 captures an image of a subject by converting incident light into an analog signal. The analog signal is transmitted via a connection 109 to an analog front end (AFE) processor 111. The analog front end processor 111 typically includes an analog-to-digital converter for converting the analog signal received from the image sensor 104 into a digital signal. The analog front end processor 111 provides this digital signal as image data via a connection 112 to the ASIC 102 for image processing.

The ASIC 102 is coupled to one or more motor drivers 119 via a connection 118. The motor drivers 119 control the operation of various parameters of the lens 122 via a connection 121. For example, lens controls, such as zoom, focus, aperture and shutter operations can be controlled by the motor drivers 119. A connection 123 between the lens 122 and the image sensor 104 is shown as a dotted line to illustrate the operation of the lens 122 focusing on a subject and communicating light to the image sensor 104, which captures the image provided by the lens 122.

The ASIC 102 also sends display data via a connection 124 to a display controller 126. The display controller may be, for example, a national television system committee (NTSC)/phase alternate line (PAL) encoder, although, depending on the application, other standards for presenting a display data may be used. The display controller 126 converts the display data from the ASIC 102 into a signal that can be forwarded via a connection 127 to an image display 128. The image display 128, which, as an example may be a liquid crystal display (LCD) or other display, displays the captured image to the user of a digital camera 100. The image display 128 is typically a color display located on the digital camera 100.

Depending on the configuration of the digital camera 100, the image shown to a user on the image display 128 may be shown before the image is captured and processed, in what is referred to as “live view” mode, or after the image is captured and processed, in what is referred to as “instant review” mode. In some embodiments, a previously captured image may be displayed in what is referred to as “review” or “playback” mode. The instant review mode is typically used to display the captured image to the user immediately after the image is captured and the playback mode is typically used to display the captured image to the user sometime after the image has been captured and stored in memory.

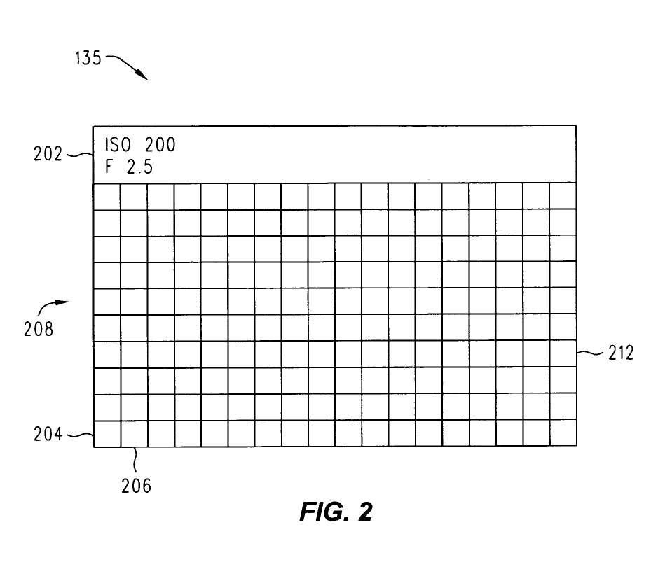

The instant review mode allows the user of the camera 100 to immediately view the captured image on the display 128. Unfortunately, because the image display 128 is typically small, only gross features, or characteristics, of the image can be visually observed. Furthermore, the image display 128 may not accurately reproduce color, tint, brightness, etc., which may further make it difficult for a user to determine the quality of the captured image. The difficulty in visually determining the quality of the captured image leads to the possibility of saving an image that may include deficiencies that, if visually detected, would likely cause the user to discard the image and attempt to capture another image having better quality. In order to determine whether the image includes deficiencies that may not be apparent to the user when viewing the captured image on the image display 128 in the instant review mode, the image analysis logic 150 dynamically analyzes one or more characteristics of the captured image. The analysis logic 150 then presents the user, via the image display 128 and a user interface, an analysis of the captured image. An exemplary dynamic analysis of the data for each pixel in a captured image is described below with reference to FIG. 2. In one embodiment, information associated with each pixel may be analyzed to determine whether a significant number of the pixels forming the image are either dark or bright. A predominance of bright pixels may be indicative of overexposure and a predominance of dark pixels may be indicative of underexposure.

It is noted that the terms of bright and dark may not necessarily refer to pixels that are saturated (clipped) due to extremely bright light or pixels that imaged no light. The term bright may refer to clipped pixels and pixels that are within a range of being clipped. Likewise, dark pixels may refer to pixels that are within a range of the dark current.

Similar dynamic analyses can be performed to determine whether an image is in focus or to determine whether the white balance is correct. In one embodiment of determining whether an image is in focus, pixels in an image are examined to determine whether sharp transitions exist between the pixels. For example, a dark pixel adjoining or in close proximity to a bright pixel may indicate that the image is in focus, while a dark pixel separated from a bright pixel by a number of gray pixels may indicate that the image is out of focus.

White balance is a characteristic of the image that generally refers to the color balance in the image to ensure that color reproductions are accurate. An image in which each pixel is a different shade of the same color may indicate an image in which the white balance is improperly adjusted.

In addition to the foregoing, an image improvement logic 160 may be provided to present to the user with a recommendation in the form of instructions presented on the image display 128 on ways in which to possibly improve a subsequent image. In other embodiments, the information may be provided via mechanisms, such as audio or speech information. For example, the image improvement logic may suggest adjusting a condition under which the image was captured or adjusting a setting or parameter used to capture the image. As will be described below, in one embodiment the image analysis logic 150 analyzes the captured image and, optionally, the camera settings used to capture the image, and determines a value of one or more characteristics of the captured image. For example, to determine whether the exposure of the image is satisfactory, if a predefined number of white pixels in the image is exceeded, then the image analysis logic 150 may indicate that the image is overexposed. Further, if the image analysis logic 150 determines that one or more characteristics of the captured image is not satisfactory to yield a high quality image, the image improvement logic 160 may determine whether a condition used to capture the image should be adjusted, or whether a camera setting should be adjusted, to improve a subsequent image. For example, if the image analysis logic 150 determines that the image is underexposed, the image improvement logic 160 may determine that a subsequent image may be improved by activating the camera flash for a subsequent image.

When the image analysis logic 150 analyzes the data representing the captured image and the setting used to capture the image, the analysis can be used by the image improvement logic 160 to suggest adjustments to the settings to improve a subsequent image. These suggested adjustments to the camera settings or parameters can be presented to the user on a help screen via the image display 128, or, in an alternative configuration, can be automatically changed for a subsequent image.

It is noted that the image analysis logic 150 and the image improvement logic 160 may be a single unit. For example, they may exist in the same firmware or be a single computer program. They have been split into separate functions herein solely for illustration purposes.

The ASIC 102 is coupled to a microcontroller 161 via a connection 154. The microcontroller 161 can be a specific or general purpose microprocessor that controls the various operating aspects and parameters of the digital camera 100. For example, the microcontroller 161 may be coupled to a user interface 164 via a connection 162. The user interface 164 may include, for example but not limited to, a keypad, one or more buttons, a mouse or pointing device, a shutter release, and any other buttons or switches that allow the user of the digital camera 100 to input commands.

The ASIC 102 is also coupled to various memory modules, which are collectively referred to as memory 136. The memory 136 may include memory internal to the digital camera 100 and/or memory external to the digital camera 100. The internal memory may, for example, comprise flash memory and the external memory may comprise, for example, a removable compact flash memory card. The various memory elements may comprise volatile, and/or non-volatile memory, such as, for example but not limited to, synchronous dynamic random access memory (SDRAM) 141, illustrated as a portion of the memory 136 and flash memory. Furthermore, the memory elements may comprise memory distributed over various elements within the digital camera 100.

The memory 136 may also store the image analysis logic 150, the image improvement logic 160, the settings file 155 and the various software and firmware elements and components (not shown) that allow the digital camera 100 to perform its various functions. The memory also stores an image file 135, which represents a captured image. When the system and method for analyzing an image is implemented in software, the software code (i.e., the image analysis logic 150) is typically executed from the SDRAM 141 in order to enable the efficient execution of the software in the ASIC 102. The settings file 155 comprises the various settings used when capturing an image. For example, the exposure time, aperture setting (f-stop), shutter speed, white balance, flash on or off, focus, contrast, saturation, sharpness, ISO speed, exposure compensation, color, resolution and compression, and other camera settings may be stored in the setting file 155. As will be described below, the setting file 155 may be accessed by the image analysis logic 150 to analyze a captured image by, in one example, determining the camera settings used to capture the image that is under analysis.

The ASIC 102 executes the image analysis logic 150 so that after an image is captured by the image sensor 104, the image analysis logic 150 analyzes various characteristics of the captured image. These characteristics may include characteristics of the captured image, or alternatively, may include the settings used to capture the image. Further, if the image improvement logic 160 determines that the image could be improved by changing one or more of the conditions under which the image was captured, or by changing one or more camera settings, then the image improvement logic 160 can either suggest these changes via the user interface 164 and the image display 128, or can automatically change the settings and prepare the camera for a subsequent image. Embodiments of the analysis are described in greater detail below.

FIG. 2 is a graphical illustration of an image file 135. The image file 135 includes a header portion 202 and a pixel array 208. The header portion or other portion may include data, sometimes referred to herein as metadata, that indicates settings of the camera or conditions in which the image was captured. The metadata may be analyzed to determine whether improvements to subsequent images may be made. The pixel array 208 comprises a plurality of pixels or pixel values, exemplary ones of which are illustrated using reference numerals 204, 206 and 212. Each pixel in the pixel array 208 represents a portion of the captured image represented by the image file 135. An array size can be, for example, 2272 pixels wide by 1712 pixels high. When processed, the image file 135 can also be represented as a table of values for each pixel and can be stored, for example, in the memory 136 of FIG. 1. For example, each pixel has an associated red (R), green (G), and blue (B) value. The value for each R, G and B component can be, for example, a value between 0 and 255, where the value of each R, G and B component represents the color that the pixel has captured. For example, if pixel 204 has respective R, G and B values of 0, 0 and 0, respectively, (or close to 0,0,0) the pixel 204 represents the color black, or is close to black. Conversely, for the pixel 212, has a respective value of 255 (or close to 255) for each R, G and B component represents the color white, or close to white. R, G and B values between 0 and 255 represent a range of colors between black and white.

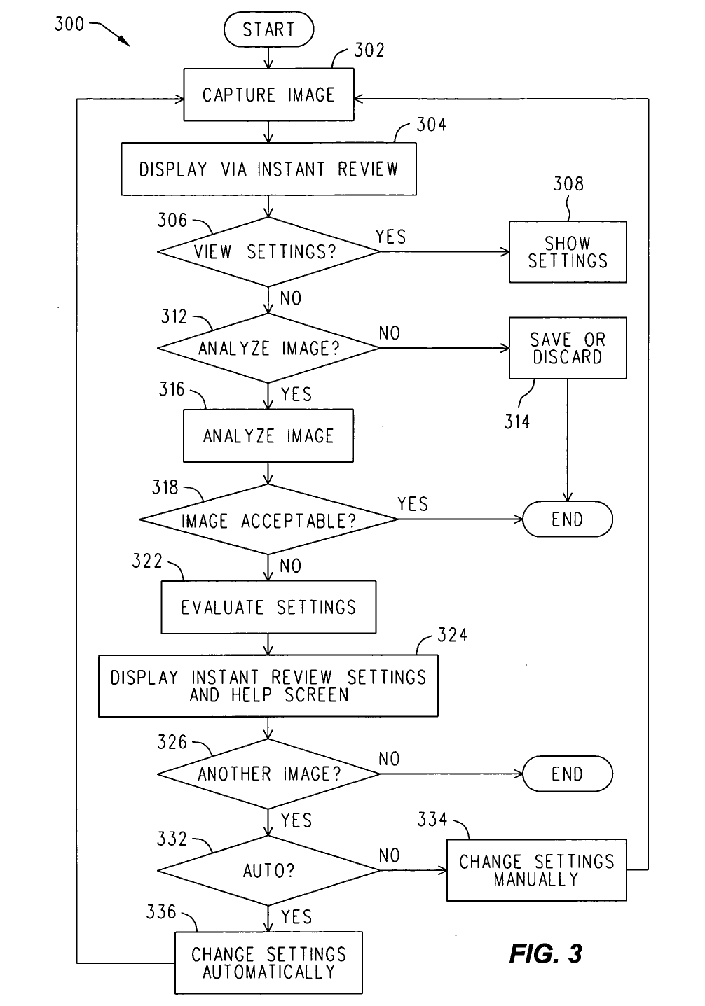

The data for each pixel in the image file 135 can be analyzed by the image analysis logic 150 to determine characteristics of the image. For example, characteristics including, but not limited to, the exposure, focus or the white balance of the captured image can be analyzed. A predominance of white pixels may be indicative of overexposure and a predominance of black pixels may be indicative of underexposure. To determine whether an image is in focus, pixels in an image are analyzed to determine whether sharp transitions exist between pixels. For example, a black pixel adjoining a white pixel may indicate that the image is in focus, while a black pixel separated from a white pixel by a number of gray pixels may indicate that the image is out of focus. An image in which each pixel is a different shade of the same color may indicate a problem with the white balance of the image. An example of determining the exposure will be described below with respect to FIG. 3.

FIG. 3 is a flow chart 300 describing the operation of an embodiment of the image analysis logic 150 and the image improvement logic 160 of FIG. 1. Any process descriptions or blocks in the flow chart to follow should be understood as representing modules, segments or portions of code which include one or more executable instructions for implementing specific logical functions or steps in the process, and alternative implementations are included within the scope of the preferred embodiment. For example, functions may be executed out of order from that shown or discussed, including substantially concurrently or in reverse order, depending on the functionality involved, as would be understood by those reasonably skilled in the art of the present invention.

In block 302 the image sensor 104 of FIG. 1 captures an image. The image is stored in the memory 136 as image file 135. In block 304, the image represented by the image data is displayed to the user of the digital camera 100 via the image display 128 of FIG. 1 during the “instant review” mode. The instant review mode affords the user the opportunity to view the captured image subsequent to capture.

In decision block 306, the user determines whether he or she wants to view the settings with which the image was captured. If the user wants to view the settings, the settings are displayed to the user on the image display 128 as indicated in block 308. If the user does not want to view the settings, then, in decision block 312, it is determined whether the user wants the image analysis logic 150 to analyze the image. If the user does not want the image to be analyzed, then, in block 314 the image can be saved or discarded. Alternatively, the image analysis logic 150 can be invoked automatically without user intervention.

In block 316, the image analysis logic 150 analyzes the data within the image file 135. The data is analyzed to determine various characteristics of the captured image. The following example will use exposure as the characteristic that is analyzed by the image analysis logic 150. However, other characteristics, such as, focus and white balance, can be analyzed. Analysis of several of these other characteristics will be described in greater detail below.

When analyzing exposure, the image analysis logic 150 performs a pixel by pixel analysis to determine whether the image includes a predominance of either black or white pixels. It should be noted that rather than sampling all the pixels constituting the image, a sample of the pixels may be analyzed. In this example, the data associated with each pixel in the image file 135 is analyzed to determine whether a pixel is a black pixel or a white pixel. Each pixel is analyzed to determine its corresponding R, G and B values. For example, if the R, G and B values for the pixel 204 are all zeros, the pixel is considered a black pixel. Each pixel in the pixel array 208 is analyzed in this manner to determine the number of black or white pixels in the pixel array 208 for this image file. A determination in block 306 that a substantial portion of the pixels in the array 208 are black indicates that the image is likely underexposed. Conversely, a determination that many of pixels in the array 208 are white indicates that the image is likely overexposed. Of course the image may be of an all white or an all black subject, in which case the user may choose to disregard the analysis.

In an alternative embodiment, the data in the image file 135 can be analyzed in combination with other data available either in the image file 135 or from the settings file 155 in the camera 100. For example, additional data, sometimes referred to as metadata, saved in the header 202 of the image file 135 can be analyzed in conjunction with the information from each pixel in the array 208. This information might include, for example, the ISO setting and the aperture setting (f-stop) used to capture the image. These data items can be used in conjunction with the pixel data above to develop additional information regarding the characteristic of the analyzed image. Analysis of the settings will be described in greater detail below.

Furthermore, the image analysis logic 150 can also analyze the camera settings used to capture the image and use those settings when analyzing the data in the image file 135 to develop additional data regarding the image file 135. For example, the image analysis logic 150 can access the settings file 155 in the memory 136 of FIG. 1 to determine, for example, whether the flash was enabled, or to determine the position of the lens when the image was captured. In this manner, the image analysis logic 150 can gather a range of information relating to the captured image to perform an analysis on the captured image file 135 to determine whether the captured image meets certain criteria. To illustrate an example, if the image analysis logic 150 determines that the image is underexposed, i.e., the image file contains many black pixels, the image analysis logic 150 can access the settings file 155 to determine whether the flash was active when the image was captured. If the image analysis logic 150 determines that the flash was turned off, the image analysis logic 150 may communicate with the image improvement logic 160 to recommend that the user activate the flash so that a subsequent image may have less likelihood of being underexposed. It should be noted that the settings file 155 may be appended to the image file 135.

In decision block 318, it is determined whether the image data analyzed in block 316 represents an acceptable image. This can be an objective determination based on criteria that the user enters into the camera 100 via a user interface 164, FIG. 1, or can be preset in the camera 100 at the time of manufacture. Alternatively, the determination of whether the image data represents an acceptable image can be a subjective determination based on user input. If the image is determined to be acceptable, then no further calculations or analysis are performed.

If, however, in decision block 318 the image analysis logic 150 determines that certain conditions under which the image was captured or settings used to capture the image can be changed to improve the image, then, in block 322, the image improvement logic 160 evaluates the settings used to capture the data in the image file 135 to determine whether a condition or setting can be changed to improve the image. In addition, the image improvement logic 160 can also develop recommendations to present to the user of the camera to improve a subsequent image. For example, if the analysis in block 316 suggests that the image was underexposed, the image improvement logic 160 may develop “advice” to be presented to the user. In this example, as will be described below, the image improvement logic 160 may suggest that the user activate the flash to improve a subsequent image. This suggestion may be provided to the user via the image display 128 in conjunction with the user interface 164.

In block 324, an instant review of settings and a help screen is displayed to the user. The instant review and help screen may include, for example, a thumbnail size display of the image, a display of the setting used to capture the image, an evaluation of the image and, if the user desires, suggestions on ways to improve the image. The evaluation of the image may include, for example, a notification that characteristics, such as exposure, focus and color balance are satisfactory. Suggestions on ways in which to improve the image may be communicated to the user via the image display 128 and may include, for example, changing a condition under which the image was captured, changing a setting with which the image was captured, or a combination of both changing a condition and a setting.

In decision block 326, the user determines whether another image is to be captured. If the user does not want to capture another image, the process ends. If, however, in decision block 326, the user wants to capture another image, then, in decision block 332, it is determined whether the user wants to manually change a parameter, such as a condition or setting, for the subsequent image or, if the parameter is to be set automatically by the digital camera 100, FIG. 1.

If, in decision block 332, the user decides to manually change the setting, then, in block 334, the user changes the setting and the process returns to block 302 where another image is captured and the process repeats. If, however, in decision block 332, the user wants the digital camera 100 to automatically change the setting, then, in block 336, the setting used to capture the previous image are changed according to the new setting determined in block 324. The process then returns to block 302 to capture a subsequent image.

Having described some embodiments of analyzing characteristics of an image and camera settings, other embodiments will now be described.

In the following embodiments, the data in the header 202, FIG. 2, of an image file 135 is sometimes referred to as metadata. As described above, the metadata may include several characteristics related to the camera settings at the time the image was captured. These settings may be settings adjusted manually by the user or automatically by the camera. In some embodiments of the image analysis logic 150, the metadata, and not the data representative of the pixels 208, is analyzed.

It should be noted that the following analysis provides determinations of some of the possible anomalies that may be detected by the image analysis logic 150. Thus, fewer or more possible anomalies may be detected. The following analysis also provides information related to correcting the anomalies. It is noted that the analysis may occur during a live view when an live image of a scene is displayed on the camera. The analysis may also occur after an image is captured.

### FOCUS ERRORS

Focus Problems Due to Low Contrast in the Scene

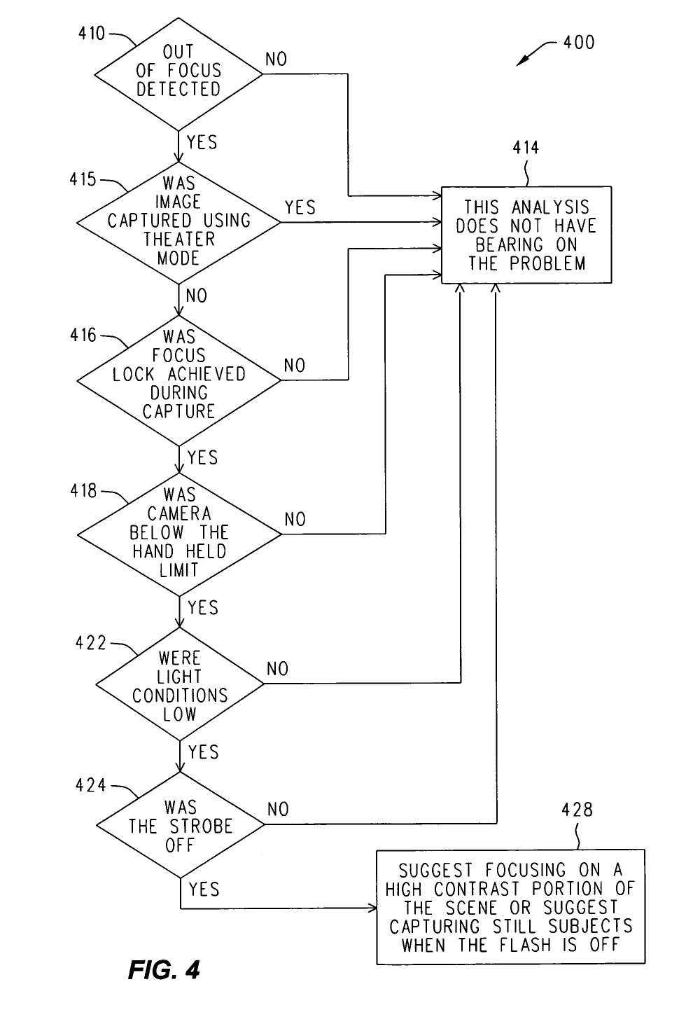

The processing program may analyze several items in the metadata to determine that the image may be blurry due to shaking of the camera at the time the image was captured. An embodiment for determining whether the image may be blurry is shown in the flowchart 400 of FIG. 4. Other methods of detecting focus problems due to shaking are described further below.

In step 410 of FIG. 4, an out of focus determination is made. This determination may be made after the image is captured. The out of focus determination may be stored in metadata and is indicative of programs and the like used by the camera to determine whether an image was captured with the camera in focus. For example, the metadata may store information indicating whether the camera achieved a focus lock at the time of image capture.

If the image was out of focus, processing proceeds to block 414, which simply indicates that the analysis of flowchart 400 has no bearing on the problem. This information is not necessarily displayed for the user of the camera.

At decision block 415, a decision is made as to whether the image was captured using a theater mode or a similar mode. A theater mode is a mode wherein the camera is used to capture an image without distracting subjects in the scene. For example, the theater mode may be used to capture images in a theater without distracting the performers in the theater. In theater mode, the flash or strobe is off. In addition, any light emitted by the camera to assist in focusing is also off. Because theater mode is typically used indoors with the flash turned off, the camera uses a high ISO, which causes high gain and low shutter speed. If the image was captured using theater mode, processing proceeds to block 414 as described above. It is noted that the advice provided per the flowchart 400 may, in some embodiments, be given regardless of whether the camera is in a theater or similar mode.

If the decision of decision block 415 is negative, processing proceeds to decision block 416 where a determination is made as to whether focus lock was achieved during image capture. During image capture, the camera attempts to focus the scene. If the scene is able to be focused at the time of image capture, focus lock is achieved. If focus lock was not achieved at the time of image capture, processing proceeds to block 414 as described above. It is noted that the focus detection of decision block 410 may analyze the image while the focus lock of decision block 416 may analyze the metadata to determine if focus lock was achieved at the time of image capture. It is noted that in some embodiments, decision blocks 410 and 416 may be combined into a single decision block.

If focus lock was achieved per decision block 416, processing proceeds to decision block 418 where a determination is made as to whether a “handheld” limit was exceeded during image capture. The handheld limit is a function of zoom and exposure time. The basis for the handheld limit is that a user of a camera who holds the camera is going to shake the camera during image capture, which is going to blur the image. The camera may be programmed with a handheld number or limit, which may be based on the amount of shaking a typical user shakes while holding the camera. It is noted that a longer exposure time or greater zoom increases the handheld calculation closer to or beyond the handheld limit because longer exposure and greater zoom will increase the possibility of a blurred image. Functions associated with the handheld limit may be assigned values so that a value may be calculated for the handheld limit. Accordingly, the handheld limit may be compared to a predetermined value to determine whether the handheld limit exceeds the predetermined value.

If the camera was not below the handheld limit at the time of image capture, processing proceeds to block 414 as described above. If the camera was below the handheld limit at the time of image capture, processing proceeds to decision block 422. The decision at decision block 422 determines if light conditions were low or below a predetermined value at the time of image capture. If the light conditions were not low at the time of image capture, processing proceeds to block 414 as described above. If the light conditions were low during image capture, processing proceeds to decision block 424. As set forth above, the camera may be used in the theater mode in low light conditions.

Decision block 424 determines whether the strobe was off during image capture. If the strobe was on during image capture, processing proceeds to block 414 as described above. If the strobe was off during image capture, the analysis is complete and processing proceeds to block 428 where advice may be provided to the camera user. The advice may be in any form, such as text or audio. The information provided to the camera user may suggest focusing on a high contrast portion of the scene during image capture. Digital cameras typically use the center of the scene for focusing, so the user may want to make sure that the center portion of the scene contains high contrast areas. The advice may also include informing the camera user to capture images of still scenes rather than scenes in which objects may be moving.

Another embodiment of the flowchart 400 includes situations wherein the camera was in a burst mode during image capture. The burst mode causes the camera to capture several simultaneous images, usually with a single activation of a capture button. When images are captured using burst mode, the flash is typically forced off because of the time required to charge the power source for the flash delays image capture. In such a situation, the advice provided to the user may include not using burst mode in low light conditions.

Blurry Image Using Night Mode

When images are captured at night, various camera modes can be used to enhance the images, which would otherwise be dark. The night modes use long exposure times and may or may not use a flash depending on the scene being captured.

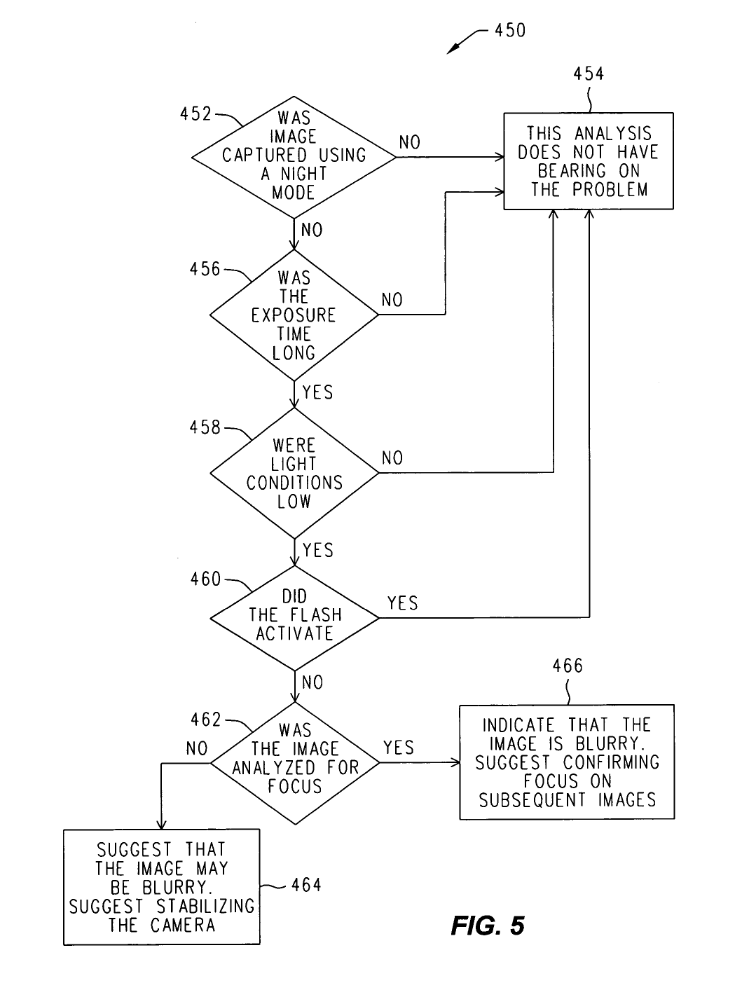

One analysis of images captured in a night mode is described with reference to the flow chart 450 of FIG. 5. The analysis commences at decision block 452 where a decision is made as to whether the image was captured using a night mode. If the image was not captured using a night mode, processing proceeds to block 454, which terminates the present analysis. Further analysis may be performed on the image to determine other anomalies or enhancements.

If the image was captured using a night mode, processing proceeds to decision block 456 where a determination is made as to whether the exposure time was long. More specifically, decision block 456 may determine whether the exposure time was greater than a preselected value. If the exposure time was not long, processing proceeds to block 454 as described above.

If the exposure time per decision block 456 was long, processing proceeds to decision block 458, where a decision is made as to whether light conditions were low during image capture. In low light conditions, the ambient light is below a predetermined value. If the light conditions were not low during image capture, processing proceeds to block 454 as described above.

If the light conditions were low at the time the image was captured, processing proceeds to decision block 460 where a decision is made as to whether the flash or strobe activated during image capture. If the strobe did activate, processing proceeds to block 454 as described above. Other embodiments of capturing images in a night mode using the strobe are described below.

If the strobe did not activate during image capture, processing proceeds to decision block 462 where a decision is made as to whether the image was analyzed for focus. In the embodiments wherein advice is provided as the image is being captured or before the image is captured, the image likely is not analyzed for focus. More specifically, given the conditions up to this point, advice as indicated in block 464 may be provided to the user. The information states that the image may be out of focus and that the image may be improved by stabilizing the camera during image capture.

If the image was analyzed for focus, processing proceeds to block 466. More specifically, metadata or other data associated with the image may be analyzed to determine if the camera obtained focus prior to being captured. Thus, the suggestions may include obtaining focus lock prior to capturing the image. The suggestions may also include stabilizing the camera or subjects within the scene during image capture.

Some embodiments of the camera have a mode for capturing images of objects at night, wherein the images are located in close proximity to the camera. One such embodiment is referred to as night portrait mode. In these modes, the camera uses a long exposure time in addition to a strobe. A procedure as described with regard to the flowchart 450 may be used to determine if images captured using a night portrait mode are blurry. Rather than determining whether an image was captured using a night mode in decision block 452, the analysis may determine whether the image was captured using a night portrait mode.

In addition, decision block 460 would determine whether the strobe activated during image capture and processing would proceed to block 454 if the strobe did not activate. The advice provided in blocks 464 and 466 may include additional suggestions advising persons in the scene to remain still for a longer period. More specifically, the camera may have an exposure time that is longer than the strobe, which requires persons to remain still longer than the time of the strobe activation.

### STROBE OUT OF RANGE

Camera strobes have a limited range. When strobes are used to illuminate objects beyond the range of the strobes, the objects will not be illuminated properly for image capture. The resulting image will be dark or portions of the image intended to be illuminated will be dark. An additional factor that darkens the images is that the exposure time is typically reduced when using a strobe. Therefore, a dark scene is captured using a short exposure time and a strobe that cannot illuminate the scene.

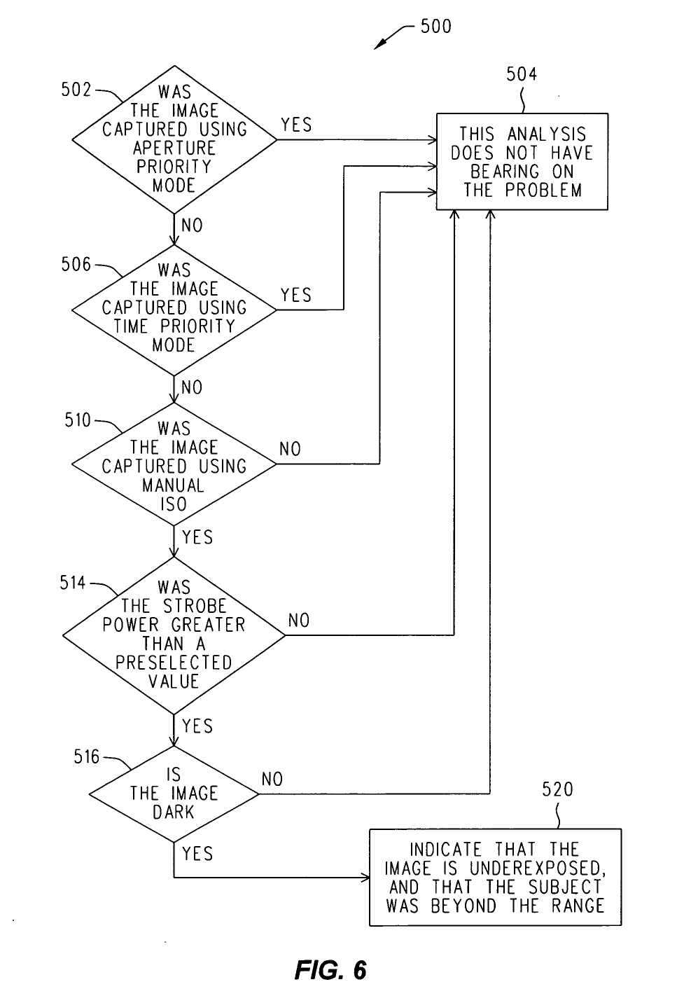

Embodiments for determining whether an image was captured using a strobe when subjects in the image were out of range of the strobe are described in the flowchart 500 of FIG. 6. Processing commences with decision block 502 that determines whether an image was captured using aperture priority mode. Aperture priority mode is a mode wherein the user of the camera selects the aperture during image capture. Data stored in the metadata may indicate whether the camera was in aperture priority mode. If the camera was in aperture priority mode during generation of the image data, processing proceeds to block 504 where processing continues to the next analysis. More specifically, the suggestion for improving image quality ultimately offered by the flowchart 500 will not be applicable to the camera setting.

If the camera was not in aperture priority mode, the analysis continues to decision block 506 where a determination is made as to whether the camera was in time value mode during image capture. Time value mode is sometimes referred to as Tv mode. The time value mode enables a user to select the shutter speed of the camera, which determines the exposure time during image capture. More specifically, the shutter speed determines the amount of time that the photosensors charge during image capture. If the shutter speed is set too slow, the image may be over exposed. Likewise, if the shutter speed is set too fast, the image will be under exposed. If the camera was in time value mode during image capture, processing proceeds to block 504 as described above.

If the camera was not in time value mode during image capture, processing proceeds to decision block 510 where a determination is made as to whether the ISO was set manually for the image capture. If the ISO was not set manually, processing proceeds to block 504 as described above. In some embodiments, the processing may determine if the ISO is equal to 400 and may continue processing if the ISO is equal to 400 or thereabout.

If the conditions of decision block 510 are met, processing proceeds to decision block 514 where a determination is made based on the strobe power during image capture. In some embodiments, the decision determines whether the strobe activated at full power or at a power greater than a preselected value during image capture. In some embodiments, the decision determines the period in which the strobe was active during image capture. For example, the decision may determine whether the strobe time was greater than one half second. If the conditions of decision block 514 are not met, processing proceeds to block 504 as described above.

If the conditions of decision block 514 are met, processing proceeds to decision block 516 where a determination is made as to whether the image is dark. Determining whether the image is dark may be achieved using a plurality of different methods. One embodiment includes determining the average value of the pixels or the average value of some of the pixels. The average value is compared to a preselected value wherein the image is deemed dark if the average value is less than the preselected value. If the image is not deemed to be dark, processing proceeds to block 504 as described above.

If the image is deemed to be dark at decision block 516, processing proceeds to block 520 where an indication is provided that the subject of the image may have been out of range of the strobe. Suggestions for correcting the image may also be provided and may include moving closer to the subject or deactivating the strobe and using a longer exposure time.

### IMAGE ENHANCEMENTS

The metadata and other data may be used to provide the user with ways to improve the image quality. The program may analyze the settings or different camera parameters at the time of image capture and may provide suggestions for improving the image during subsequent image capture.

Adaptive Lighting

Some cameras include processing that lightens dark regions of an image and/or masks bright portions of an image to prevent further brightening. This process balances extreme contrasts in the image. For example, a subject may be dark when it is captured using a bright background. In some embodiments, the camera analyzes the ISO used to capture the image. If the ISO was set below a preselected value and the adaptive lighting was set, the camera may provide information indicating that the image may appear unrealistic or grainy. The camera may also provide information for improving the image including using a lower ISO or setting the camera to an automatic ISO.

Too High Contrast in the Scene

The image data and the metadata may be analyzed to determine if the contrast in the scene is high or greater than a predetermined value. The high contrast may result in the subject of the image being in a shadow. In one embodiment, the following analysis is not performed in panoramic or portrait modes. Images captured using the panoramic mode may have high contrasts due to the nature of capturing panoramic images. Likewise, images captured using the portrait mode may be subject to high contrast due to the nature of capturing portrait images.

The number of dark and clipped pixels in various portions of the image may be analyzed to determine the contrast. For example, pixel values in the center of the image may be analyzed to determine if they are generally greater than a predetermined value. Pixel values in other regions of the image may be analyzed to determine if they are generally less than a predetermined value. If a high number of pixel values are clipped and dark, the contrast may be too high. The camera may display information suggesting setting the camera to lower ambient lighting as a basis for image processing, which may lower the contrast. In some embodiments, the program may suggest setting an adaptive lighting setting lower so as to capture images that may be located in shadows in the scene.

The camera may provide advice related to setting an adaptive lighting setting to low. The adaptive lighting setting reduces the effects of low light in the scene and, thus, may reduce the high contrast.

In some embodiments all or some of the following criteria may be applied before the advice to use low adaptive lighting is given. The EV compensation may be analyzed wherein the information is provided if the EV compensation is greater than 2.0. In addition, the information may be provided if the exposure time is less than one second. The information may be provided if the ISO is between 64 and 100. In some embodiments, the information is provided if the strobe activated during image capture and a return flash was detected.

Panoramic Image Improvements

Some cameras include a panoramic mode that enables a user to capture a plurality of images and connect or stitch the images together. The camera bases the stitching on high contrast portions of the image. Images captured using a wide angle and other settings may have too many distortions to perform stitching.

In some embodiments, the camera determines if the camera is in a macro mode or if the camera was used to capture close images. The macro mode may be defined by a setting on the camera. Determining whether the images are close up may be accomplished by determining the range of the focus. If any of these conditions are met, the camera may provide information indicating that the image may be distorted. Advice may include moving away from the subject. General advice may also be provided suggesting using a tripod with a rotatable head so that the camera is able to be carefully swept across the scene.

What is claimed is:

1. A method of analyzing an image captured by a digital camera, said method comprising:
providing information regarding changing at least one camera setting if:
said image is out of focus;
said image was captured using an ISO above a preselected value;
said camera was able to obtain a focus lock during image capture;
said camera was below a predetermined handheld limit during image capture;
the light intensity at the time of image capture was below a predetermined value; and
a strobe associated with said digital camera was not activated during image capture.

2. The method of claim 1, wherein said information comprises suggesting focusing on a high contrast portion of a scene represented by said image.

3. The method of claim 1, wherein said information comprises suggesting capturing images of scenes containing still objects.

4. The method of claim 1, wherein said information comprises suggesting activating a strobe.

5. The method of claim 1, wherein if said camera was in a mode wherein said camera captures a plurality of simultaneous images with a single activation of a switch, said information comprises suggesting deactivating said mode.

6. The method of claim 5, wherein said information comprises deactivating said mode wherein said camera captures a plurality of simultaneous images with a single activation of a switch.

7. A method of analyzing an image captured by a digital camera, said method comprising:
providing information regarding changing at least one camera setting if:
said camera comprises a mode for capturing images in low light conditions and said camera was in said mode during image capture;
said image was captured using an exposure time greater than a preselected time;
the light intensity at the time of image capture was below a predetermined value; and
a strobe associated with said digital camera was not activated during image capture.

8. The method of claim 7, wherein said information comprises indicating that said image may be out of focus.

9. The method of claim 7 and further comprising analyzing said image to determine if the focus of said image is below a preselected value.

10. The method of claim 9, wherein said information comprises indicating that said image is out of focus.

11. The method of claim 10, wherein said camera comprises an indication when said focus is greater than said preselected value, and wherein said information comprises obtaining said indication during image capture.

12. The method of claim 7, wherein said information comprises suggesting stabilizing said camera during image capture.

13. A method of analyzing an image captured by a digital camera, said method comprising:
providing information regarding changing at least one camera setting if:
said image was captured with said camera being in a mode where a user selects an aperture;
said image was captured with said camera being in a mode where a user selects the exposure time;
said image was captured using an ISO having a preselected value;
a strobe associated with said camera activated during image capture and the intensity of said strobe was greater than a preselected value; and
a preselected number of pixels associated with said image have values below a preselected value.

14. The method of claim 13, wherein said preselected value of said ISO is about 400.

15. The method of claim 13, wherein said preselected value of said ISO corresponds to an ISO selected by a user.

16. The method of claim 13, wherein said preselected intensity associated with said strobe corresponds to said strobe being activated during image capture for a period greater than a preselected period.

17. The method of claim 16, wherein said preselected period is about one half second.

18. The method of claim 7, wherein said image comprises providing information suggesting reducing the distance between said camera and subjects in said image during a subsequent image capture.

19. A method of analyzing an image captured by a digital camera, said method comprising:
providing information regarding changing at least one camera setting if:
said image was captured with said camera being in a mode other than a panoramic mode;
the Ev compensation was greater than a preselected value during image capture;
the ISO was below a preselected value during image capture; and
the contrast in the image is greater than a preselected value.

20. The method of claim 19, where said preselected value of said Ev compensation is about 2.0

21. The method of claim 19, wherein said preselected value of said ISO is 100.

22. The method of claim 19 and further comprising providing said information if a strobe associated with said camera activated during image capture and said strobe was within a preselected distance from at least one subject in said image.

23. The method of claim 19, wherein said information comprises suggesting using a processing mode wherein light features of said image are darkened.

24. A method of improving an image captured by a digital camera, wherein said image comprises a plurality of images that are stitched together, said method comprising providing information regarding changing at least one camera setting if at least one subject of said image was within a preselected distance from said camera during image capture.

25. The method of claim 24, wherein said preselected distance is about two meters.

26. The method of claim 24, wherein said information comprises moving away from said at least one subject.
